(19) United States
(12) Patent Application Publication
(10) Pub. No.: US 2002/0150747 A1
(43) Pub. Date: Oct. 17, 2002

(54) Structural composite

(76) Inventors: Scott A. Wellman, Plymouth, MI (US); Paul Wolfe, (US)

Correspondence Address: HARNESS, DICKEY & PIERCE, P.L.C., P.O. BOX 828, BLOOMFIELD HILLS, MI, 48303, US

(21) Appl. No.: 10/079,840

(22) Filed: Feb. 19, 2002

Related U.S. Application Data
(60) Provisional application No. 60/269,277, filed on Feb. 16, 2001.

(51) Int. Cl. B32B 27/04; D03D 15/00; D03D 25/00; B32B 27/12; B32B 17/12; B32B 18/00

(52) U.S. Cl. 428/293.7; 442/181; 428/383; 428/297.4

(57) ABSTRACT

The present invention relates to a composite of materials having at least one large loop of continuous reinforcement within a vinyl ester resin. The composite further has spanner structures formed by using either chopped or woven mat fibers to span areas not incorporating the loops of large continuous fiber reinforcement.

### CROSS-REFERENCE TO RELATED APPLICATIONS

This application is a United States Patent Application claiming priority to U.S. Provisional Application No. 60/269,277 filed on Feb. 16, 2001, the disclosure of the which is incorporated herein by reference.

### FIELD OF THE INVENTION

The present invention relates generally to composite materials and to methods of manufacturing the composite materials. In particular, the composite material of the present invention utilizes a combination of continuous fibers in the form of loops and chopped or woven fibers.

### BACKGROUND OF THE INVENTION

While not in any way limited to automotive components, the present invention was conceived in part to meet the need in the automotive industry. Heretofore, automotive suspension components have largely been manufactured from steel due to its known strength and relative durability. These steel automotive components however, suffer from several known disadvantages such as weight and lack of corrosion resistance.

In contrast, the composite material of the present invention is resistant to corrosion and tends to be lightweight (generally at least 50%) lighter than steel components. Further perceived advantages include better damping characteristics, reduction in part counts, and speedy assembly times, among a host of other advantages.

### SUMMARY OF THE INVENTION

The present invention relates to composite materials having at least one large loop of continuous fiber reinforcement within a vinyl ester resin. Further, the composite has either chopped or mat fibers which span areas not incorporating the loops of large continuous fiber reinforcement.

The present invention also relates to methods of manufacturing the composite materials for specific applications. The method generally comprises steps of:

a. Providing a vinyl ester base in a mixing machine;

b. Adding a stabilizer and a mold release compound to the mixer;

c. Mixing the resin for a predetermined amount of time;

d. Providing continuous fibers;

e. Coating the continuous fibers with the uncured vinyl ester base;

f. Allowing the coated glass fibers to maturate for a predetermined amount of time;

g. Forming a loop structure with the coated glass fibers wherein the fibers are generally parallel;

h. Placing the fibers within a mold;

i. Curing the epoxy under pressure and heat.

Further details and advantages of the composite according to the invention, of the method and of the device, are described with reference to the embodiment illustrated in the drawings.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIGS. 1a-c represent views of composite structures manufactured according to the teachings of the present invention;

FIG. 2 represents the use of the laminate loops according to first embodiment of the present invention;

FIGS. 3a-c represent a second composite structure formed according to the teaching of the present invention;

FIG. 4 represents the continuous fiber lay up of the component taught in FIGS. 3a through 3c; and

FIGS. 5a-c represent views of a third composite structure according to the teachings of the present invention.

### DETAILED DESCRIPTION OF THE PREFERRED EMBODIMENTS

The following description of the preferred embodiments are merely exemplary in nature and is in no way intended to limit the invention, its application, or uses.

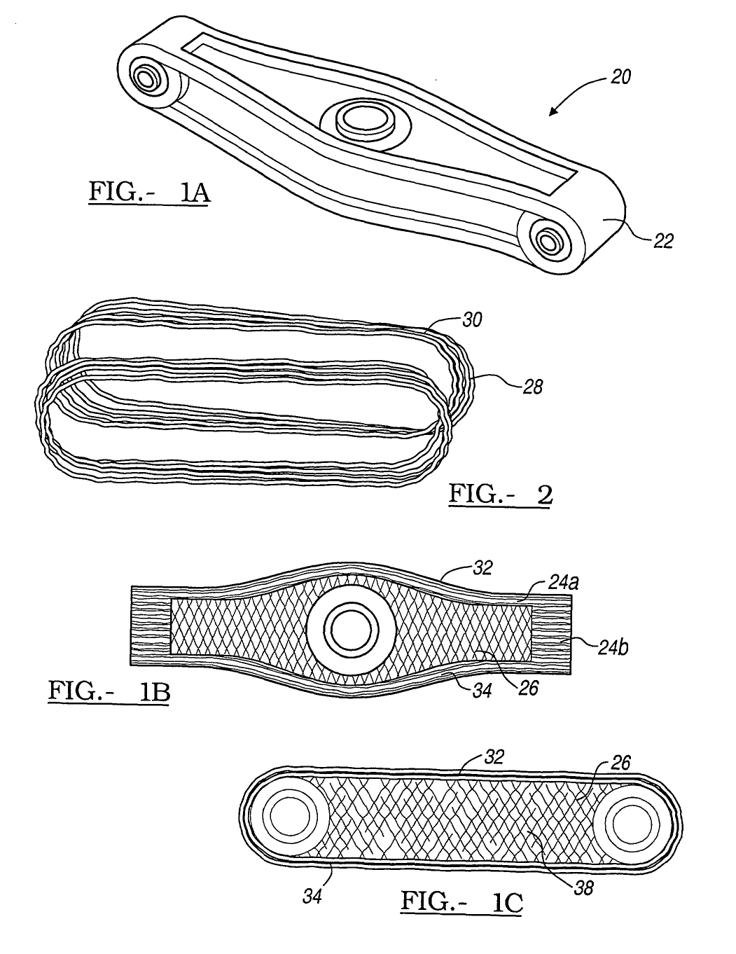

FIGS. 1a-c depict the components of a composite 20 in accordance with the teachings of the present invention. Shown is a component 22 formed from a reinforced vinyl ester resin. By reinforced it is meant that the vinyl ester resin includes fibers such as glass, synthetic fibers such as Kevlar®, carbon fibers, metallic fibers or particulate by way of non limiting example. Preferably, each component contains very large loops of continuous fibers which are incorporated into the load bearing portions of the structure. Additionally, fibers in the form of a woven mat, individual fibers in chopped or unchopped form or combinations thereof can be used in generally non-load bearing areas to assist in holding the structure together. Particularly useful as a continuous fibers are e-glass yarns, available from Owens Corning. A commercially available vinyl ester resin, which is useful in accordance with the teaching of the present invention is made by Dow Chemical, with the e-glass yarn. Under a highly preferred embodiment, the main component 22 will be formed of a multi-layer construction designated by references numerals 24a and b.

The base materials include, continuous and chopped glass fibers, vinyl ester resin, and a small percentage of inhibitors and curatives. Magnesium dioxide is added to maturate the material. Zinc striate is used as a mold release. Alternative resin systems include polyesters and epoxies. A typical batch of resin would consist of; about 15 kg of vinyl ester resin, from 201-200 grams and preferably 600 grams of magnesium dioxide, and 100-700 grams and preferably 400 grams of zinc striate, 200 grams of epoxy coloring, and from 10 to 14 grams and preferably 12 grams of inhibitor and about 100 to 150 grams and preferably 125 grams of catalyst. A mixer is used to combine the resin and magnesium dioxide. The zinc stearate is added slowly until all incorporated. The inhibitor and catalyst are added to the mixture separately and mixed for about 15 minutes using a twin sheer blade mixer.

Once produced, the vinyl ester mixture is combined with the continuous fibers to form a pre-preg layer 24a. Initially, doctor boxes are used to distribute chopped glass randomly over the continuous fiber pre-preg layer 24a. The pre-preg layer 24a is wrapped in plastic and compacted and rolled to an appropriate thickness and density. The material is then allowed to maturate for about 48 hours at 68° F. At this point, it can be rolled off, measured, and cut into desired lengths for molding. It is additionally possible to produce the composite by simply taking the coated fiber directly to the mold. For low volume parts, a low temperature long cure cycle process can be used.

After maturation, the pre-preg 24a is cut into predetermined widths with a slitter. The plastic covering is removed from the pre-preg 24 and the pre-preg 24 is wrapped into large loops on a winding machine to fit into the mold. The size of these loops are very important and must correspond to the overall geometry of the load bearing portions. For example, a truck suspension component has two pieces of material cut 4.5 meters long, which are wrapped into two large loops. A single webbing piece of pre-preg being 2.5 meters long is cut for the web section. The original wrapped material is wrapped on a fixture and loaded into the mold. The webbing or spanner piece 26 is inserted into the center of the mold generally perpendicular to the large loops. The material is placed into the mold and the material is cured under pressure and temperatures for a predetermined amount of time. After curing, the part is removed from the mold and de-flashed if required. The part may continue to secondary assembly or shipping directly out of the mold.

As previously mentioned, prior to curing, the continuous fibers 28 are incorporated into the resin bed to form a pre-preg laminate 24. The specific fibers and volume fractions of fibers within the uncured epoxy are dependent upon the engineering specification of the component being produced. Generally, however, the thickness of the component will be modified by using multiple layers of the uncured resin materials. With reference generally to FIG. 2, the layers of the materials are formed into large loops 30 which are incorporated in their uncured state into the mold. After being cured and shaped by the mold, these large loops will become the load bearing portions of the assembly 20. For example, the vehicle suspension component depicted in FIGS. 1a-b is designed to accept tensile and compressive loading. Most of the stresses are borne by the top and bottom 32 and 34 of the generally I-beam construction. The spanner 26 between the top and bottom portion 32 and 34 is formed using either a resin chopped fiber mix or a resin woven glass construction. While this construction is capable of taking some load, it is envisioned that a majority of the load will be taken by the top and bottom portions of the I-beam construction. The continuous fibers 28 increase both the strength and consistency of production parts. Short fiber reinforced parts can have knit lines where the fibers/resin do not fully form one part. The continuous fibers 28 allow the part to be made without these knit lines, thus reducing the number of failure locations sites.

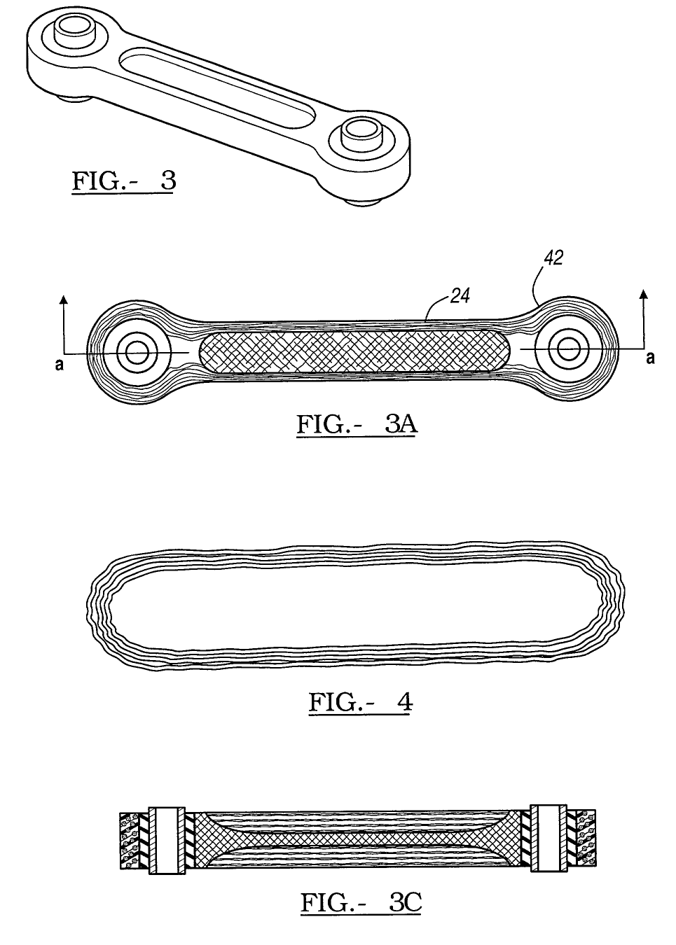

FIGS. 3a-3c represent and alternate composite according to the teachings of the present invention. Shown is a spanner bar 40, which is designed to take a compressive as well as tensile loads. The spanner bar 40 has a plurality of continuous fiber laminate layers 24 generally surrounding the periphery 42 of the structure.

FIG. 3c depicts a cross-sectional view of the spanner bar 40. Shown are the laminate layers 24 as well as the chopped fiber reinforced central portion 42. As can be seen, each end 44a and 44b define a through bore 46. Disposed within the through bore 46 is a rubber grommet 48 and steel bushing 50. The through bore 46 can be formed to accept and hold the rubber grommet 48.

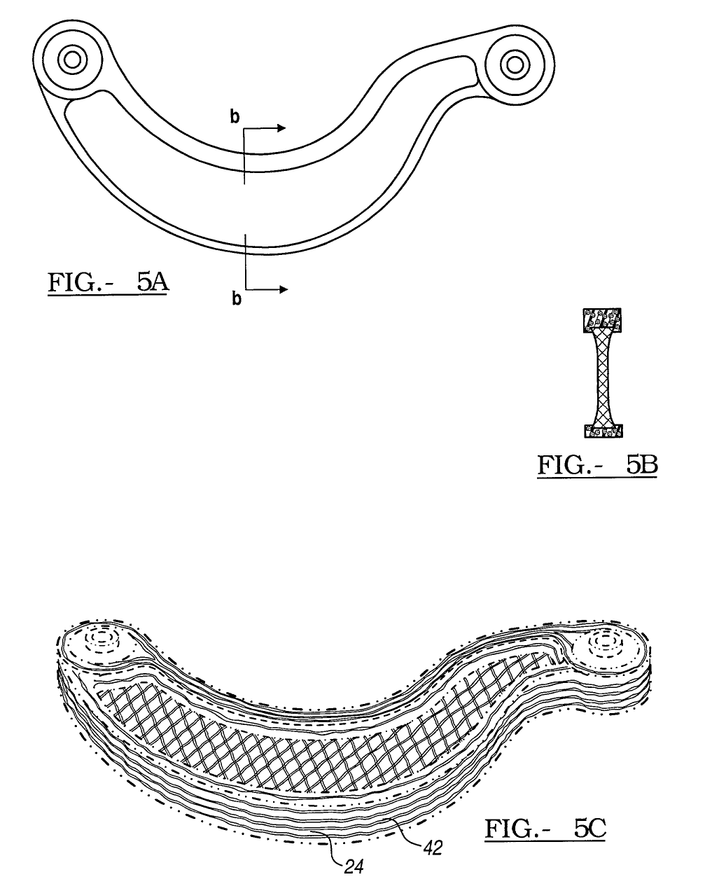

FIGS. 5a-5c represent views of a third embodiment of the present invention. Showed is another suspension component 56 having a general U-shape. As can best be seen in FIG. 5b, the component generally has an I-beam cross section. As with each of the examples previously described, the structure has a plurality of laminate layers 24 disposed about the periphery of the structure. The spanner region 58 utilizes a woven mat 46 as a reinforcement. Additionally, a continuous fiber wrap can be used to surround loading points, such as grommets. The structure periphery is then surrounded by continuous fiber laminate layer 24.

Components made pursuant the present invention can have design failure modes incorporated therein. For example, a rear suspension trailing link, in a crash situation can be designed to split down the middle allowing the axle to move forward, yet maintaining its structural strength intention. This will prevent the axle from moving rearward into the fuel tank. Furthermore, the material according to the present invention is recyclable for use in low stress parts. For example, the recycled material can be used in rear doors for trucks or truck van trailers. The rear doors have two functions, first, to cover the back of the trailer and second, to hold the back of the trailer in the square which requires diagonal strength.

Molds for use with the material according to the present invention are designed with integral knot out (KO) system, which is actuated by the press. The resin is forced out of the material at high pressure and tends to “glue” the KO pins in place. The mold system that uses great force to reject the part and cleans the KO pins on each cycle. Molds and critical aspects of the part are designed with 0 degree draft angles. For example, the bushing eye of a link has no draft angle; this makes the bushing design simpler and more durable. With this regard, bushings can be incorporated directly into the structure without bushing housings, thus reducing weight and costs.

Further, the material according to the present invention has a 5× higher damping ratio as compared to steel (depending upon the design). This increases in damping, reduces the high frequency residence associated with certain steel and aluminum parts. This resonance is a contributor to poor noise properties in the vehicle. Further, as vibration dampers are used to dampen known vibrations, conventional dampers use rubber as a flexible element. The rubber deflection needs to be limited due to durability concerns. As opposed to the use of conventional dampers, the material according to the present invention can be modified to increase specific masses along nodal points 38 of known resonant frequencies for the component. This increases the overall damping of the structure and reduces the necessary material thicknesses for other components within the vehicle. Additionally, it reduces secondary assembly costs as it will reduce the number of mass vibration dampers needed on a vehicle.

By way of non-limiting example, preferred method for producing a composite produce with the invention will now be described with reference to the figures, including FIGS. 2 and 3 in particular. Production of the composite which has the e-glass yarn imbedded in the resin is prepared by the following steps:

Utilizing a sheer blade mixer, first place Durakan 790 from Dow Chemical into a mixing apparatus. Mix slowly for four minutes while adding MgO₂, zinc striate from Ferro Corporation, Cleveland, Ohio, and a predetermined epoxy coloring. While mixing, add a 7080 inhibitor in the form of a para-benzoquinone blended in a diallyl phthalate monomer from Plasticcolors, Inc. of Ohio and 320a accelerant for 15 minutes while constantly monitoring the material temperature so that it does not exceed 80 degrees Farenheight. E-glass yarns being made of glass fibers purchased from Owens Corning Fiberglass are provided. Each continuous e-glass yarn should be larger than 15 feet in length and more preferably, larger than 20 feet in length and even more preferably, larger than 25 feet in length. The continuous e-glass yarns are coated with resin to form a pre-preg material.

Next in the process, an e-glass chopped fiber material is provided. The chopped glass material is randomly disposed over the pre-preg. The amount of chopped glass to be disposed should be such that 10 to 30% and preferably 20% of the weight of the glass should be chopped glass and 40 to 70% and preferably 80% of the weight should be linear glass. The resin and glass should be run through a standard rolling machine to adjust the thickness of the material. The total mixture ratio is dependent on the product to be made. For example, for a suspension link, a ratio of 38% resin to 62% e-glass by weight is desirable. After the material has been made, it is necessary for it to maturate for 40 hours at 70° F. before use. The material now has a two week shelf life for manufacturing use.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A composite comprising:
a coil of laminate material, said laminate material comprising a plurality of continuous reinforcement fibers disposed within a polymer matrix.

2. A composite structure according to claim 1 where said laminate defines a first surface, said first surface having chopped fibers disposed thereon.

3. The composite structure according to claim 2 wherein about 10-30% of the fibers are chopped fibers.

4. The composite structure according to claim 3 wherein about 20% of the fiber is chopped fiber.

5. The composite structure according to claim 1 further comprising a woven fiber mat.

6. The composite according to claim 1 wherein s aid matrix is a vinyl ester.

7. The composite according to claim 1 further comprising a spanner.

8. The composite according to claim 7 wherein said spanner comprises chopped fibers.

9. The composite according to claim 1 where said fibers are selected from the group of e-glass, Kevlar® and carbon fibers.

10. The composite according to claim 1 where said continuous fiber is a yarn.

11. A method for providing a composite material comprising the steps of:
providing a laminate pre-preg film having a plurality of parallel continuous fibers disposed in an uncured polymer matrix;
forming a coil of said laminate; and
applying pressure and elevated temperature to said coil to cure the polymer.

12. The method according to claim 11 further comprising the step of providing a spanner.

13. The method according to claim 12 further comprising the step of disbursing chopped fibers over said pre-preg laminate, prior to forming a coil of said laminate.

14. A composite structure comprising a coil of laminate material, said laminate material comprising a plurality of continuous reinforcement fibers disposed within a polymer matrix and having a first surface having chopped fibers disposed thereon;
said matrix comprising a vinyl ester.

15. The composite structure according to claim 14 wherein about 10%-30% by weight of the fibers are chopped fibers.

16. The composite structure according to claim 15 wherein about 20% by weight of the fibers are chopped fibers.

17. The composite structure according to claim 16 further comprising a spanner.

18. The composite structure according to claim 17 wherein said spanner comprises chopped fiber.

19. The composite structure according to claim 18 wherein said continuous fiber is a yarn comprising e-glass.

20. The composite structure according to claim 18 wherein said chopped fiber is selected from the group of e-glass, Keviar® and carbon fiber.
